(19) United States
(12) Patent Application Publication
(10) Pub. No.: US 2015/0017307 A1
(43) Pub. Date: Jan. 15, 2015

(54) SPREADABLE PREPARATION WITH HERBS

(71) Applicant: DMK Deutsches Milchkontor GmbH, Zeven (DE)

(72) Inventors: Marina Schomacker, Sittensen (DE); Michael Hahn, Heerlingen (DE)

(21) Appl. No.: 14/326,906

(22) Filed: Jul. 9, 2014

(30) Foreign Application Priority Data
Jul. 15, 2013 (EP) 13 176456.5

(51) Int. Cl. A23C 15/12; A23C 15/02

(52) U.S. Cl. CPC A23C 15/12; A23C 15/02; A23C 15/126
USPC 426/581; 426/603

(57) ABSTRACT

Disclosed are spreadable preparations, containing
(a) about 72 to about 85% by weight of butter or a synthetic glyceride mixture having a similar fatty acid spectrum,
(b) about 2 to about 5% by weight of a low-melting-point butter fraction, and
(c) about 10 to about 26% by weight of a herb preparation,
   with the proviso that the amounts indicated add up to 100% by weight.

### FIELD OF THE INVENTION

The invention pertains to the field of foods and concerns a preparation with herbs that is spreadable at room temperature, particularly a so-called “herb butter”.

### PRIOR ART

The EU Spreadable Fat Ordinance and the German Butter Ordinance define the term butter and the various types thereof quite specifically. These Ordinances describe it as a fat spread that remains solid at 20° C. and is spreadable, in the form of a solid, elastic emulsion, predominantly of the W/O type, that consists exclusively of milk and/or certain milk products having fat as an essential component. Other substances necessary for production may be added, provided that these substances are not intended to completely or partially replace a milk component. Butter has a fat content of at least 80 and at most 90% by weight, a maximum water content of 16% by weight, and a maximum non-fat dry milk solid content of 2% by weight. The high content in the fat of saturated fatty acids (an average of 69% by weight) and its low content of polyunsaturated fatty acids (an average of 3% by weight) are characteristic. The product designation “butter preparation” may be used for composite products having a milk fat content of at least 62% by weight.

In contrast, mixed spreadable fats are products in the form of a solid vegetable emulsion derived from solid and/or liquid vegetable and/or animal products and have a milk fat content of 10 to 80% by weight of the total fat content.

In the present invention, the terms “with butter” or “blended butterfat” are used collectively for all products containing butter, regardless of their fat content and percentage of milk fat.

Butter is a pure and natural foodstuff that is used in food not only because of its good taste, but also because of the nutrients it contains. Because of its content of fat-soluble vitamins A, D, E and beta-carotene, butter is a significant source of vitamins, and also provides minerals such as calcium. Butter also contains easily-digestible milk fat. However, butter is solid when refrigerated. It is therefore difficult to spread immediately after removal from the refrigerator.

Conventional herb butter is a blend consisting essentially of butter and herbs. It is frequently used to refine the taste of soups and vegetables and as a garnish and topping for fish and meat dishes. Herb butter is used not only in the kitchen, but outdoors, e.g. at back-yard barbecues or picnics. Herb butter is often used over long periods, as it is eaten only occasionally and in small amounts compared to pure butter.

Nevertheless, a drawback of herb butter is that like pure butter, it is solid when refrigerated, and therefore difficult to spread. Particularly in the case of herb preparations, however, it is preferable if the product is softer and can easily be spread even when cold. In outdoor use in particular, it must be possible to simply and hygienically serve a herb preparation with butter.

Such preparations are well known from prior art.

German Utility Model DE 20 2006 011 600 U1 (Meggle) discloses a herb preparation with butter that comprises 10 to 70% by weight of butter and 20 to 80% by weight of non-fat components such as buttermilk, low-fat milk, yogurt and/or water, herbs, and preservatives.

The subject matter of German Utility Model DE 20 2011 102 569 U1 (Meggle) concerns herb preparations with butter that have (i) a fat component containing butter and vegetable oil and (ii) herbs and/or vegetables comprising flavouring additives and are characterized in that the total fat content is 20 to 60% by weight and the ratio of total fat content to the total content of herbs and/or vegetables is from 2.5:1 to 1:2.5.

German Utility Model DE 20 2006 010 784 U1 (Meggle), for example, claims a butter-containing herb preparation, characterized in that the composition comprises 10 to 70% by weight of butter and 5 to 40% by weight of herb paste with a water content of 80 to 75% by weight and (a) low-melting-point butter fractions and/or (b1) 1 to 10% by weight of high-melting-point vegetable fats selected from palm oil and coconut oil and (b2) 0 to 50% by weight of low-melting-point vegetable fats selected from rapeseed oil, sunflower oil, corn oil and olive oil.

These butter preparations are indeed easy to process when cold, but this rheological advantage is achieved by reducing the butter content in favour of unspecified amounts of milk, yogurt, low-melting-point butter fractions, or considerable amounts of vegetable fats. For this reason, the typical taste of butter tends to be distorted or at least pushed into the background by a rather synthetic flavour that can only be compensated for by increased addition of spices, flavours, and in some cases salt and is assessed by the consumer as negative.

There is therefore a need to provide a ready-to-use herb preparation with butter that is spreadable at temperatures as low as 10° C., has a butter content of more than 70, and preferably more than 75% by weight, contains vegetable fats or vegetable oils only in amounts of up to about 5% by weight, and of course is dimensionally stable at room temperature, can be hygienically packaged, is easy to serve in portions, and can be resealed after use.

The object of the present invention is to provide a butter preparation with herbs that meets the above complex set of requirements.

### DESCRIPTION OF THE INVENTION

The subject matter of the invention is a spreadable preparation, containing
(a) about 72 to about 85 and preferably about 75 to about 80% by weight of butter or a synthetic glyceride mixture having a similar fatty acid spectrum,
(b) about 2 to about 5% by weight of a low-melting-point butter fraction, and
(c) about 10 to about 26% by weight of a herb preparation,
   with the proviso that the amounts indicated add up to 100% by weight.

Surprisingly, it was found that butter preparations with herbs can be produced that can already be spread without difficulty at temperatures of about 10° C.—i.e. refrigerator temperature—and nevertheless have a butter content of more than 70, and preferably even more than 75% by weight. As they do not require the addition of vegetable triglycerides based on palm oil or coconut oil, they provide a genuine butter taste that does not need to be masked by other flavours. Conversely, the preparations finally provide sufficient dimensional stability at room temperature, i.e., they do not melt.

### Butter and Low-Melting-Point Butter Fractions

The production of butter is based on separation of the cream from cow's milk. The main components of butter are therefore milk fats, which are primarily composed of triglycerides and fatty acids. Examples of the fatty acids found in butter include butyric acid, caproic acid, caprylic acid, capric acid, lauric acid, myristic acid, myristoleic acid, pentadecanoic acid, palmitic acid, palmitoleic acid, margaric acid, stearic acid, oleic acid, elaidic acid, linoleic acid, and linolenic acid. Milk fat has a relatively high content of short-chain saturated fatty acids and a relatively low content of polyunsaturated fatty acids (such as linoleic acid and linolenic acid).

Depending on the fat molecule in question, the melting points of the milk fats contained in butter range from about 4 up to 50° C. Using these differences in melting points, butter can be physically separated by fractionation, i.e. separated into individual fractions having special physical properties.

In fractionation of milk fat, dehydrated butter is heated and then cooled to the desired crystallisation temperature. The high-melting-point triglycerides crystallize first, and the lower-melting-point portion remains in liquid form. In a process for two-stage fractionation known in the art, for example, the fractions “stearin” (clear melting point 41 to 48° C.) and “olein” are separated in a first step. In a second step, the two fractions can be fractionated again. One then obtains from “stearin” a “hard stearin” with a melting point of 46° C. and a “soft stearin” with a melting point of 36° C. The “olein” can be separated into a “midfraction” with a melting point of 26° C. and “super olein” with a melting point of 12° C. or below. During fractionation, triglycerides are accumulated from long-chain saturated fatty acids in the higher-melting-point phase, and more short-chain and unsaturated fatty acids are accumulated in the lower-melting-point phase.

This makes it possible to alter the respective percentages of the various milk fats and thus modify the properties of a blended butterfat. In particular, the melting point of a blended butterfat can be regulated by varying the composition of the milk fats. In the composition of the present invention, depending on the fraction, fractionated butterfats promote both moldability at refrigeration temperatures and dimensional stability at room temperature. These butter fats preferably show a melting temperature of about 8 to about 12° C.

In order to manufacture a preparation having the desired moldability at room temperature, the herb preparation with butter can provide a greater percentage of low-melting-point butter fractions compared to butter. The percentage of the additional low-melting-point butter fractions can be selected as desired in order to obtain a herb preparation with butter having the desired consistency. There are no limitations on the selection of the particular butter fractions of the percentage in which they are contained in the composition according to the invention. It is within the scope of knowledge of the person with ordinary skill in the art to select the amount of the butter fractions to be used according to the type of butter fractions and any other components contained in the composition in such a manner that the desired consistency is achieved. The low-melting-point butter fractions are therefore contained in an amount of about 2 to about 5, and preferably about 2.5 to about 3.5% by weight.

### Herb Preparation

By using a combination of herbs and butter containing low-melting-point butter fractions, particularly butter oils, a herb preparation with butter is obtained that is capable of being spread and applied immediately after removal from the refrigerator and can be shaped and moulded without difficulty. In this case, the herb preparation with butter according to the invention also remains dimensionally stable at room temperature.

There are no limitations on the type of herbs contained in the composition according to the invention. Examples of suitable herbs and spices include wild garlic, basil, mugwort, savoury, borage, watercress, dill, tarragon, chervil, cress, coriander, marjoram, melissa, peppermint, oregano, paprika, parsley, pepper, salad burnet, rosemary, sage, sorrel, chives, thyme, and hyssop, either individually or in any desired combinations. The herbs may be added to the herb preparation with butter in any form desired. For example, they may be contained in chopped, finely diced form, as an extract, in fresh form, or in dried, frozen, or heat-treated form.

In a first embodiment, the preparations contain component (c) in the form of finely chopped fresh herbs. Alternatively, an aqueous herb paste may also be used, preferably having a water content of about 50 to about 85% by weight.

It has been found to be advantageous to use a pre-prepared herb paste having a water content of about 60 to 75% by weight and a dry matter content of 25 to 40% by weight, and preferably e.g. water content of 70% by weight and dry matter content of about 30% by weight. The herb paste may contain various fresh, frozen, or dried herbs and/or spices as needed. In a preferred embodiment, the herb paste includes e.g. herbs, salt, spices, garlic and onions. The herb paste is preferably used in the butter-containing herb preparation in an amount of about 15 to 26, and more preferably 18 to 20% by weight.

### Vegetable Fats and Vegetable Oils

As explained above, the inclusion of vegetable fats or vegetable oils is not required in the preparations according to the invention. In selected cases, however, it may be advantageous to add small amounts of these substances of up to 5% of the weight of the preparation.

Vegetable fats impart to the butter-containing herb preparation greater dimensional stability at room temperature. They serve as a matrix for the composition. Natural vegetable fats such as hardened palm oil or coconut oil are particularly well-suited for this purpose.

Conversely, vegetable oils impart to the composition even lower viscosity and promote moldability at refrigeration temperatures. Examples include rapeseed oil, sunflower oil, corn oil, and olive oil.

### Further Additives

The herb preparation with butter may also contain further additives as needed. Examples of such components are buttermilk, synthetic or natural flavourings, and preferably natural flavourings, salt, spices, garlic, onions, and acidifiers and antioxidants.

The use of buttermilk, for example, allows the fat content of the composition according to the invention to be reduced and a lower-fat, lower-calorie product to be obtained.
(A) Flavourings. The preparations according to the invention may contain one or more flavourings. Typical examples include: acetophenone, allyl caproate, alpha-ionone, beta-ionone, anisaldehyde, anisyl acetate, anisyl formate, benzaldehyde, benzothiazole, benzyl acetate, benzyl alcohol, benzyl benzoate, beta-ionone, butyl butyrate, butyl caproate, butylidenephthalide, carvone, camphene, caryophyllene, cineol, cinnamyl acetate, citral, citronellol, citronellal, citronellyl acetate, cyclohexyl acetate, cymol, damascone, decalactone, dihydrocoumarin, dimethyl anthranilate, dodecalactone, ethoxyethyl acetate, ethylbutyric acid, ethyl butyrate, ethyl caprinate, ethyl capronate, ethyl crotonate, ethyl furaneol, ethyl guaiacol, ethyl isobutyrate, ethyl isovalerate, ethyl lactate, ethyl methyl butyrate, ethyl propionate, eucalyptol, eugenol, ethyl heptylate, 4-(p-hydroxyphenyl)-2-butanone, gamma-decalactone, geraniol, geranyl acetate, grapefruit aldehyde, methyl dihydrojasmonate (e.g. Hedion®), heliotropin, 2-heptanone, 3-heptanone, 4-heptanone, trans-2-heptenal, cis-4-heptenal, trans-2-hexenal, cis-3-hexenol, trans-2-hexenoic acid, trans-3-hexenoic acid, cis-2-hexenyl acetate, cis-3-hexenyl acetate, cis-3-hexenyl caproate, trans-2-hexenyl caproate, cis-3-hexenyl formate, cis-2-hexyl acetate, cis-3-hexyl acetate, trans-2-hexyl acetate, cis-3-hexyl formate, para-hydroxybenzyl acetone, isoamyl alcohol, isoamyl isovalerate, isobutyl butyrate, isobutyraldehyde, isoeugenol methyl ether, isopropylmethylthiazole, lauric acid, levulinic acid, linalool, linalool oxide, linalyl acetate, menthol, menthofuran, methyl anthranilate, methylbutanol, methyl butyric acid, 2-methylbutyl acetate, methyl caproate, methyl cinnamate, 5-methyl furfural, 3,2,2-methyl cyclopentenolone, 6,5,2-methyl heptenone, methyl dihydrojasmonate, methyl jasmonate, 2-methyl methyl butyrate, 2-methyl-2-pentenoic acid, methylthiobutyrate, 3,1-methylthiohexanol, 3-methylthiohexyl acetate, nerol, neryl acetate, trans,trans,2,4-nonadienal, 2,4-nonadienol, 2,6-nonadienol, 2,4-nonadienol, nootkatone, delta-octalactone, gamma-octalactone, 2-octanol, 3-octanol, 1,3-octenol, 1-octyl acetate, 3-octyl acetate, palmitic acid, paraldehyde, phellandrene, pentanedione, phenylethyl acetate, phenylethyl alcohol, phenylethyl alcohol, phenylethyl isovalerate, piperonal, propionaldehyde, propyl butyrate, pulegone, pulegol, sinensal, sulphurol, terpinene, terpineol, terpinolene, 8,3-thiomenthanone, 4,4,2-thiomethyl pentanone, thymol, delta-undecalactone, gamma-undecalactone, valencene, valeric acid, vanillin, acetoin, ethyl vanillin, ethyl vanillin isobutyrate (=3-ethoxy-4-isobutyryloxybenzaldehyde), 2,5-dimethyl-4-hydroxy-3(2H)-furanone, and derivatives thereof (with homofuraneol (=2-ethyl-4-hydroxy-5-methyl-3(2H)-furanone), homofuronol (=2-ethyl-5-methyl-4-hydroxy-3(2H)-furanone, and 5-ethyl-2-methyl-4-hydroxy-3(2H)-furanone being preferred), maltol and maltol derivatives (with ethyl maltol being preferred), coumarin and coumarin derivatives, gamma-lactones (with gamma-undecalactone, gamma-nonalactone, and gamma-decalactone being preferred), delta-lactones (with 4-methyl delta decalactone, massoia lactone, delta decalactone, and tuberose lactone being preferred), methyl sorbate, divanillin, 4-hydroxy-2(or 5)-ethyl-5(or 2)-methyl-3(2H)furanone, 2-hydroxy-3-methyl-2-cyclopentenone, 3-hydroxy-4,5-dimethyl-2(5H)-furanone, acetic acid isoamyl ester, butyric acid ethyl ester, butyric acid-n-butyl ester, butyric acid isoamyl ester, 3-methyl butyric acid ethyl ester, n-hexanoic acid ethyl ester, n-hexanoic acid allyl ester, n-hexanoic acid-n-butyl ester, n-octanoic acid ethyl ester, ethyl-3-methyl-3-phenyl glycidate, ethyl-2-trans-4-cis-decadienoate, 4-(p-hydroxyphenyl)-2-butanone, 1,1-dimethoxy-2,2,5-trimethyl-4-hexane, 2,6-dimethyl-5-hepten-1-al and phenylacetaldehyde, 2-methyl-3-(methylthio)furan, 2-methyl-3-furanthiol, bis(2-methyl-3-furyl)disulphide, furfuryl mercaptan, methional, 2-acetyl-2-thiazoline, 3-mercapto-2-pentanone, 2,5-dimethyl-3-furanthiol, 2,4,5-trimethylthiazole, 2-acetylthiazole, 2,4-dimethyl-5-ethylthiazole, 2-acetyl-1-pyrroline, 2-methyl-3-ethylpyrazine, 2-ethyl-3,5-dimethylpyrazine, 2-ethyl-3,6-di methylpyrazine, 2,3-diethyl-5-methylpyrazine, 3-isopropyl-2-methoxypyrazine, 3-isobutyl-2-methoxypyrazine, 2-acetylpyrazine, 2-pentylpyridine, (E,E)-2,4-decadienal, (E,E)-2,4-nonadienal, (E)-2-octenal, (E)-2-nonenal, 2-undecenal, 12-methyltridecanal, 1-penten-3-one, 4-hydroxy-2,5-dimethyl-3(2H)-furanone, guaiacol, 3-hydroxy-4,5-dimethyl-2(5H)-furanone, 3-hydroxy-4-methyl-5-ethyl-2(5H)-furanone, cinnamaldehyde, cinnamyl alcohol, methyl salicylate, isopulegol, and (not explicitly mentioned here) stereoisomers, enantiomers, positional isomers, diastereomers, cis/trans-isomers, and/or epimers of these substances.
(B) Acidifiers and antioxidants. These substances must also meet the requirements of the Food Additives Admission Ordinance within the EU. In accordance therewith, the following are examples of suitable acidifiers and/or antioxidants:
   E 300 Ascorbic acid
   E 301 Sodium ascorbate
   E 302 Calcium ascorbate
   E 304 Ascorbyl palmitate/ascorbyl stearate
   E 306 Tocopherol-containing extracts
   E 307 Alpha-tocopherol
   E 308 Gamma-tocopherol
   E 309 Delta-tocopherol
   E 310 Propyl gallate
   E 311 Octyl gallate
   E 312 Dodecyl gallate
   E 315 Isoascorbic acid
   E 316 Sodium isoascorbate
   E 319 tert-butyl hydroquinone
   E 320 Butylated hydroxyanisole (BHA)
   E 321 Butylated hydroxytoluene (BHT)
   E 322 Lecithin
   E 325 Sodium lactate
   E 326 Potassium lactate
   E 327 Calcium lactate
   E 330 Citric acid
   E 331 Mono-/di-/trisodium citrate
   E 332 Monopotassium citrate, tripotassium citrate
   E 333 Monocalcium citrate, dicalcium citrate, tricalcium citrate
   E 334 L-(+)-tartaric acid
   E 335 Monosodium tartrate, disodium tartrate
   E 336 Monopotassium tartrate, dipotassium tartrate
   E 337 Potassium sodium tartrate
   E 338 Phosphoric acid
   E 339 Monosodium phosphate, disodium phosphate, trisodium phosphate
   E 340 Monopotassium phosphate, dipotassium phosphate, tripotassium phosphate
   E 341 Monocalcium phosphate, dicalcium phosphate, tricalcium phosphate
   E 343 Magnesium phosphate
   E 350 Sodium hydrogen malate, sodium malate
   E 351 Potassium malate
   E 352 Calcium malate, calcium hydrogen malate
   E 353 Metatartaric acid
   E 354 Calcium tartrate
   E 355 Adipic acid
   E 356 Sodium adipate
   E 357 Potassium adipate
   E 363 Succinic acid
   E 380 Ammonium citrate
   E 385 Calcium disodium methylene diamine tetrahydrate
   E 392 Rosemary extract

### Spreadable Preparations

In a preferred embodiment, the spreadable preparations may show the following compositions:
(a) about 72 to about 85, and preferably about 75 to about 80% by weight of butter or a synthetic glyceride mixture having a similar fatty acid spectrum,
(b) about 2 to about 5, and preferably about 2.5 to 3.5% by weight of a low-melting-point butter fraction,
(c) about 10 to about 26, and preferably about 15 to 20% by weight of a herb preparation, and optionally,
(d) 0 to about 5, and preferably about 0.5 to about 2% by weight of vegetable fats and/or vegetable oils, and
(e) 0 to about 2, and preferably about 0.1 to about 1.0% by weight of further additives,
   with the proviso that the amounts indicated add up to 100% by weight.

### Production Method

The subject matter of the invention also includes a method for producing the preparation according to the invention, wherein components (a) and (b) are kneaded in a rotor-stator mixer and component (c) is gradually added.

### INDUSTRIAL APPLICABILITY

The herb preparation with butter according to the present invention can be placed in serving devices such as resealable tubes or dispensers, or in particular, containers. This makes it possible, even in the case of occasional use, to remove small amounts of the herb preparation with butter and then hygienically reseal the package. The herb preparation with butter comes into contact with the environment only over a small contact surface, while the remainder of the preparation is protected inside the container. Even when used outdoors, the herb preparation with butter can be hygienically removed in the required amount while the rest of the product stays protected inside the container. The herb preparation with butter according to the invention is therefore particularly advantageous for seasoning food. As it is dimensionally stable even at room temperature because of its special composition, the herb preparation with butter according to the invention is particularly well-suited for decoration purposes, for example at a buffet, where maintaining dimensional stability at room temperature is of particular importance.

### EXAMPLES

### Examples 1 to 7, Comparison Examples C1 to C3

Table 1 below gives formulation examples for spreadable butter formulations with herbs. The table shows solidification points, i.e., the temperatures at which the preparations were no longer spreadable. Dimensional stability at 20° C. was assessed on a scale of (1)=dimensionally stable to (4)=melted. Taste assessment was conducted by a panel of 5 trained taste testers. The buttery taste of the preparations was assessed on a scale of (1)=distinct to (6)=barely perceptible.

Examples 1 to 7 are according to the invention; Examples C1 to C3 are for comparison purposes.

TABLE 1
Formulation Examples

| Component | 1 | 2 | 3 | 4 | 5 | 6 | 7 | C1 | C2 | C3 |
|---|---|---|---|---|---|---|---|---|---|---|
| Butter | 72 | 75 | 80 | 82 | 85 | 80 | 80 | 60 | 70 | 80 |
| Butter oil | 2 | 2 | 3 | 3 | 4 | 3 | 2 | 10 | 10 | — |
| Buttermilk | — | — | — | — | — | 1 | — | — | — | — |
| Coconut oil | — | — | — | — | — | | 1 | — | 10 | — |
| Olive oil | — | — | — | — | — | | 1 | — | | 10 |
| Herb paste* | to 100 | | | | | | | | | |
| Citric acid | 0.1 | | | | | | | | | |
| Benzoic acid | 0.1 | | | | | | | | | |
| Solidification point [° C.] | 10 | 10 | 9 | 7 | 7 | 8 | 9 | 15 | 10 | 10 |
| Dimensional stability at | 1.5 | 1.5 | 2.0 | 2.0 | 2.0 | 2.0 | 2.5 | 1.5 | 1.5 | 3.0 |
| 20° C. | | | | | | | | | | |
| Taste assessment | 2.5 | 2.5 | 2.0 | 2.0 | 1.5 | 2.5 | 2.5 | 4.5 | 3.0 | 2.5 |

*Solid percentage 40% by weight - Remainder: water

The examples and comparison examples demonstrate that the preparations according to the invention show the most favourable results for the three properties of spreadability, dimensional stability, and buttery taste.

1. Spreadable preparation, containing
(a) about 72 to about 85% by weight of butter or a synthetic glyceride mixture having a similar fatty acid spectrum,
(b) about 2 to about 5% by weight of a low-melting-point butter fraction, and
(c) about 10 to about 26% by weight of a herb preparation,
with the proviso that the amounts indicated add up to 100% by weight.

2. Composition according to claim 1, containing about 75 to about 80% by weight of butter.

3. Composition according to claim 1, containing as component (b) about 2.5 to about 3.5% by weight of butter oil.

4. Composition according to claim 1, containing about 18 to about 20% by weight of a herb preparation.

5. Composition according to claim 1, containing as component (c) finely chopped fresh herbs.

6. Composition according to claim 1, containing as component (c) an aqueous herb paste.

7. Composition according to claim 6, wherein the water content of the aqueous herb paste is about 50 to about 85% by weight.

8. Preparations according to claim 1, also containing as optional component (d) vegetable fats and/or vegetable oils.

9. Preparations according to claim 8, containing the vegetable fats and/or vegetable oils in amounts of up to 5% by weight.

10. Preparations according to claim 8, containing as vegetable fats hardened palm oil or coconut oil.

11. Preparations according to claim 8, containing as vegetable oils rapeseed oil, sunflower oil, corn oil and/or olive oil.

12. Preparations according to claim 1, also containing as an optional component (e) further additives selected from the group consisting of buttermilk, flavourings, salt, spices, garlic, onions, acidifiers, and antioxidants.

13. Preparations according to claim 1, containing
(a) about 72 to about 85% by weight of butter or a synthetic glyceride mixture having a similar fatty acid spectrum,
(b) about 2 to about 5% by weight of a low-melting-point butter fraction,
(c) about 10 to about 26% by weight of a herb preparation, and if applicable,
(d) 0 to about 5% by weight of vegetable fats and/or vegetable oils, and
(e) 0 to about 2% by weight of further additives,
with the proviso that the amounts indicated add up to 100% by weight.

14. Method for the production of preparations according to claim 1, wherein components (a) and (b) are kneaded in a rotor-stator mixer and component (c) is gradually added.

15. Preparations according to claim 1, wherein they are placed in resealable tubes, dispensers, or containers.
